(19) United States
(12) Patent Application Publication
(10) Pub. No.: US 2023/0373504 A1
(43) Pub. Date: Nov. 23, 2023

(54) VISION OBSTRUCTION MITIGATION

(71) Applicant: Ford Global Technologies, LLC, Dearborn, MI (US)

(72) Inventors: Brendan Francis Diamond, Grosse Pointe, MI (US); Keith Weston, Canton, MI (US); Jordan Barrett, Milford, MI (US); Andrew Denis Lewandowski, Sterling Heights, MI (US); David Michael Russell, Ann Arbor, MI (US); Lars Niklas Pettersson, Novi, MI (US)

(73) Assignee: Ford Global Technologies, LLC, Dearborn, MI (US)

(21) Appl. No.: 17/747,280

(22) Filed: May 18, 2022

(51) Int. Cl. B60W 50/08; B60W 50/00; B60W 50/14; B60W 60/00; E05F 15/71; G06T 7/00

(52) U.S. Cl. CPC B60W 50/082; B60W 50/0098; B60W 50/14; B60W 60/0051; E05F 15/71; G06T 7/0002; B60W 2540/225; B60W 2420/42; B60W 2510/30; B60W 2555/20; B60W 2050/146; E05Y 2400/32; E05Y 2400/40; E05Y 2400/44; E05Y 2900/55; G06T 2207/30248

(57) ABSTRACT

A system and method for operating a vehicle to mitigate vision obstructions includes collecting data on potential vision obstructions in a sightline of an operator of a vehicle, determining, based on the data, that a vision obstruction has occurred or is about to occur, and actuating a corrective measure in the vehicle. Collected data may include camera data from inside the vehicle and estimated environmental conditions, and the collected data may be used to disable the ADAS based on a detected or impending vision obstruction.

### BACKGROUND

The Society of Automotive Engineers SAE has defined multiple levels of autonomous vehicle operation (see, e.g., SAE J3016). At levels 0-2, a human driver monitors or controls the majority of the driving tasks, often with no help from the vehicle. For example, at level 0 no automation, a human driver is responsible for all vehicle operations. At level 1 driver assistance, the vehicle sometimes assists with steering, acceleration, or braking, but the driver is still responsible for the vast majority of the vehicle control. At level 2 partial automation, the vehicle can control steering, acceleration, and braking under certain circumstances without human interaction. At levels 3-5, the vehicle assumes more driving-related tasks. At level 3 conditional automation, the vehicle can handle steering, acceleration, and braking under certain circumstances, as well as monitoring of the driving environment. Level 3 requires the driver to intervene occasionally, however. At level 4 high automation, the vehicle can handle the same tasks as at level 3 but without relying on the driver to intervene in certain driving modes. At level 5 full automation, the vehicle can handle almost all tasks without any driver intervention.

Systems at levels 2 and 3, that can autonomously steer and brake/accelerate the vehicle, typically employ monitoring systems such as steering wheel sensors and/or gaze detection to make sure that the driver is ready to take over operation of the vehicle if needed. Additionally, driver-assist systems in vehicles, such as blind spot monitoring (BSM), rear cross traffic alert (CTA), pedestrian detection (PD), and lane change assist (LCA) have been developed to aid a driver when a view of their surroundings may be obstructed. Many of these aids have been incorporated into advanced driver assistance systems (ADAS) and autonomous driving (AD) systems.

### BRIEF DESCRIPTION OF THE DRAWINGS

FIG. 1 is a block diagram of a vehicle system for vision obstruction monitoring.

FIG. 2 is an overhead diagram of a vehicle with cameras for collecting data on potential vision obstructions in a sightline of an operator.

FIG. 3 is a flow diagram for an implementation of a method of vision obstruction monitoring.

### DETAILED DESCRIPTION

In accordance with the present disclosure, measures can be taken with respect to potential vision obstructions in a sightline of an operator of a vehicle. As these sightlines are through the windows of a vehicle, data about obstructions or potential obstructions may be directly captured with one or more cameras to detect, for example, fog, fogged windows, snow, snow or ice-covered windows, road spray, mud splatter, heavy rain, or sun glare from a camera image. The data may also be data about an environment around and outside of a vehicle and may include weather reports and/or historical data, current temperature and humidity and a dewpoint chart to determine when window fogging or atmospheric fog may occur, and/or information such as windshield wiper speed or current lighting conditions to infer that heavy rain or bright glare may be obscuring visibility. When it is determined that a vision obstruction has occurred or is about to occur, a corrective measure can be actuated. The corrective measure may activate a defroster, park the vehicle, provide instructions to eliminate the vision obstruction, etc. and may disable use of an advanced driver assistance system (ADAS) since the driver cannot properly supervise the system.

In an implementation, a computer includes a processor and a memory, the memory storing instructions executable by the processor to: collect data on potential vision obstructions in a sightline of an operator of a vehicle; determine, based on the data, that a vision obstruction has occurred or is about to occur; and actuate a corrective measure in the vehicle.

The instructions to actuate the corrective measure may include instructions to disable an advanced driver assistance system (ADAS) or to prevent the ADAS from being enabled.

The instructions to collect data on potential vision obstructions may include instructions to collect camera data of views through windows of the vehicle. The camera data may be from a driver state monitoring camera (DSMC) and/or a forward-facing camera and a rearward-facing camera in an interior of the vehicle.

The instructions to collect data on potential vision obstructions may include instructions to collect estimates of environmental conditions. The estimates of environmental conditions may include real-time or near real-time weather reports for a location of the vehicle, windshield wiper speed, dewpoint data, temperature data, and/or humidity data.

The instructions to actuate the corrective measure may include instructions to activate a climate control of the vehicle, wherein the climate control is one of defrost, air-conditioning, or heat.

The instructions to actuate the corrective measure may include instructions to activate a window motor to raise or lower a window.

The instructions to actuate the corrective measure may include instructions to activate a display to provide instructions to the operator indicating steps to take to resolve the vision obstruction.

The instructions to actuate the corrective measure may include instructions to activate an autonomous driving (AD) function of the vehicle to take the vehicle to a side of a road and stop the vehicle until the vision obstruction is no longer determined.

In another implementation, a method for operating a vehicle includes: collecting data on potential vision obstructions in a sightline of an operator of the vehicle; determining, based on the data, that a vision obstruction has occurred or is about to occur; and actuating a corrective measure in the vehicle.

Actuating the corrective measure may include disabling an advanced driver assistance system (ADAS) or preventing the ADAS from being enabled.

Collecting data on potential vision obstructions may include collecting camera data of views through windows of the vehicle.

The camera data may be from a driver state monitoring camera (DSMC) and/or a forward-facing camera and a rearward-facing camera in an interior of the vehicle.

Collecting data on potential vision obstructions may include collecting estimates of environmental conditions.

The estimates of environmental conditions may include real-time or near real-time weather reports for a location of the vehicle, windshield wiper speed, dewpoint data, temperature data, and/or humidity data.

Actuating the corrective measure may include activating a climate control of the vehicle, wherein the climate control is one of defrost, air-conditioning, or heat.

Actuating the corrective measure may include activating a window motor to raise or lower a window.

Actuating the corrective measure may include activating a display to provide instructions to the operator indicating steps to take to resolve the vision obstruction.

Actuating the corrective measure may include activating an autonomous driving (AD) function of the vehicle to take the vehicle to a side of a road and stop the vehicle until the vision obstruction is no longer determined.

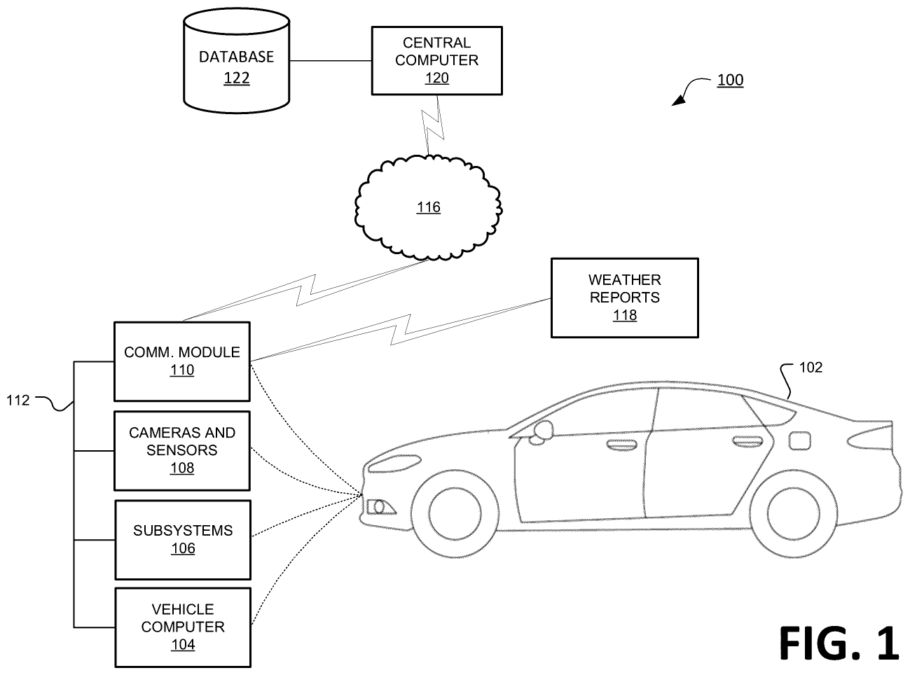

With reference to FIG. 1, a system 100 can provide vision obstruction monitoring for a vehicle 102. The vehicle 102 includes components or parts, including hardware components and typically also software and/or programming, to perform operations to operate the vehicle 102. Vehicle 102 can include a vehicle computer 104, subsystems 106, cameras and/or sensors 108, and a communications module 110. The subsystems 106 include, for example, an ADAS/AD subsystem, a braking system, a propulsion system, and a steering system as well as additional subsystems including but not limited to a navigation system, a climate control system, a lighting system, and a human-machine interface (HMI) subsystem that may include an instrument panel and an infotainment system. The propulsion system provides motive power to wheels to propel the vehicle 102 forward and/or backward, and the braking subsystem can slow and/or stop vehicle 102 movement. The steering subsystem can control a yaw, e.g., turning left and right, maintaining a straight path, of the vehicle 102 as it moves. Each of these subsystems may be controlled by the one or more vehicle computers 104, e.g., embodied as an electronic control unit (ECU) or the like.

Computers, including the herein-discussed vehicle computer 104 and central computer 120, include respective processors and memories. A computer memory can include one or more forms of computer readable media, and stores instructions executable by a processor for performing various operations, including as disclosed herein. For example, the computer can be a generic computer with a processor and memory as described above and/or a vehicle computer 104, for example, may include an electronic control unit (ECU), controller, or the like for a specific function or set of functions, and/or a dedicated electronic circuit including an ASIC that is manufactured for a particular operation, e.g., an ASIC for processing sensor data and/or communicating the sensor data. In another example, computer may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer.

A computer memory can be of any suitable type, e.g., hard disk drives, solid state drives, servers, or any volatile or non-volatile media. The memory can store data. The memory can be a separate device from the computer, and the computer can retrieve information stored in the memory, e.g., a vehicle computer 104 can obtain data to be stored via a vehicle network 112 in the vehicle 102, e.g., over a CAN bus, a wireless network, etc. Alternatively, or additionally, the memory can be part of the computer, i.e., as a memory of the computer.

The vehicle computer 104 can be included in the vehicle 102 that may be any suitable type of ground vehicle 102, e.g., a passenger or commercial automobile such as a sedan, a coupe, a truck, a sport utility, a crossover, a van, a minivan, etc. A vehicle computer 104 may include programming to operate one or more of vehicle 102 brakes, propulsion (e.g., control of acceleration in the vehicle 102 by controlling one or more of an electric motor, hybrid engine, internal combustion engine, etc.), steering, climate control, interior and/or exterior lights, etc., as well as to determine whether and when the vehicle computer 104, as opposed to a human operator, is to control such operations. Additionally, a vehicle computer 104 may be programmed to determine whether and when a human operator is to control such operations in cooperation with the ADAS/AD subsystem.

A vehicle computer 104 may include or be communicatively coupled to, e.g., via a vehicle network 112 such as a communications bus as described further below, more than one processor, e.g., included in components such as subsystems 106, electronic controller units (ECUs) or the like included in the vehicle 102 for monitoring and/or controlling various vehicle components, e.g., a powertrain controller, a brake controller, a steering controller, etc. The computer is generally arranged for communications on a vehicle 102 communication network that can include a bus in the vehicle 102 such as a controller area network (CAN) or the like, and/or other wired and/or wireless mechanisms. Alternatively, or additionally, in cases where the computer includes a plurality of devices, the vehicle 102 communication network may be used for communications between devices represented as the computer in this disclosure.

The vehicle network 112 is a network via which messages can be exchanged between various devices in vehicle 102. The vehicle computer 104 can be generally programmed to send and/or receive, via vehicle network 112, messages to and/or from other devices in vehicle 102 e.g., a vehicle computer 104 (i.e., any or all of ECUs), cameras and/or sensors 108, actuators, components, communications module 110, a human machine interface HMI subsystem, etc. Additionally, or alternatively, messages can be exchanged among various such other devices in vehicle 102 via a vehicle network 112. In cases in which the computer includes a plurality of devices, vehicle network 112 may be used for communications between devices represented as a computer in this disclosure. Further, as mentioned below, various controllers and/or subsystems 106 may provide data to the computer. In some implementations, vehicle network 112 can be a network in which messages are conveyed via a vehicle 102 communications bus. For example, vehicle network 112 can include a controller area network (CAN) in which messages are conveyed via a CAN bus, or a local interconnect network (LIN) in which messages are conveyed via a LIN bus. In some implementations, vehicle network 112 can include a network in which messages are conveyed using other wired communication technologies and/or wireless communication technologies e.g., Ethernet, Wi-Fi, Bluetooth, Ultra-Wide Band (UWB), etc. Additional examples of protocols that may be used for communications over vehicle network 112 in some implementations include, without limitation, Media Oriented System Transport (MOST), Time-Triggered Protocol TTP, and FlexRay. In some implementations, vehicle network 112 can represent a combination of multiple networks, possibly of different types, that support communications among devices in vehicle 102. For example, vehicle network 112 can include a CAN in which some devices in vehicle 102 communicate via a CAN bus, and a wired or wireless local area network in which some device in vehicle 102 communicate according to Ethernet or WI-FI communication protocols.

The vehicle computer 104 and/or central computer 120 can communicate via a wide area network 116 to access information from a database 122, which may, for example, include current or historical environmental condition information used for providing estimates of environmental conditions to vehicle 102, such as based on time, GPS position of the vehicle 102, and current and/or past weather conditions. Further, various computing devices discussed herein may communicate with each other directly, e.g., via direct radio frequency communications according to protocols such as Bluetooth or the like. For example, a vehicle 102 can include a communication module 110 to provide communications with devices and/or networks not included as part of the vehicle 102, such as the wide area network 116 and/or an online, radio, or infrastructure source of local real-time or near real-time weather reports 118, for example. The communication module 110 can provide various communications, e.g., vehicle to vehicle (V2V), vehicle-to-infrastructure or everything (V2X) or vehicle-to-everything including cellular communications (C-V2X) wireless communications cellular, dedicated short range communications (DSRC), etc., to another vehicle 102, to an infrastructure element typically via direct radio frequency communications and/or typically via the wide area network 116, e.g., to the central computer 120. The communication module 110 could include one or more mechanisms by which a vehicle computer 104 may communicate, including any desired combination of wireless e.g., cellular, wireless, satellite, microwave and radio frequency communication mechanisms and any desired network topology or topologies when a plurality of communication mechanisms are utilized. Exemplary communications provided via the module can include cellular, Bluetooth, IEEE 802.11, DSRC, C-V2X, and the like.

As discussed in more detail below, data from cameras and/or sensors 108, weather reports 118, and/or database 122 may be used by vehicle computer 104 to determine that a vision obstruction has occurred or is about to occur in the vehicle 102.

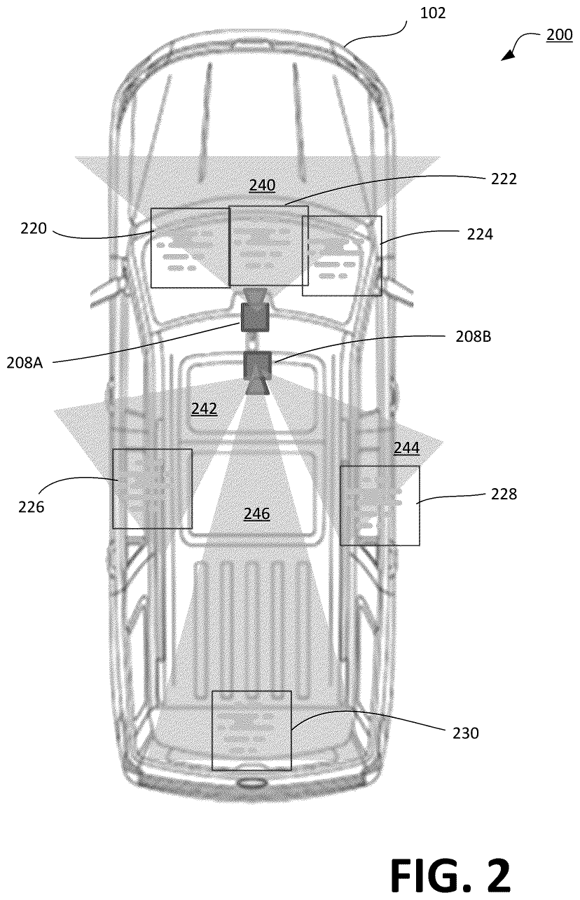

With reference to FIG. 2, an overhead diagram 200 of an example implementation of the present disclosure is illustrated, in which a vehicle 102 has cameras 208A, 208B for collecting data on potential vision obstructions 220-230 in a sightline of an operator. While cameras 208A, 208B are disclosed as a data source in this implementation, implementations of the present disclosure are not limited to use of forward-facing camera 208A and rearward-facing camera 208B, and may use other data sources, including but not limited to a driver state monitoring camera (DSMC), real-time or near real-time weather reports 118 for a location of the vehicle 102, current windshield wiper speed, dewpoint data (e.g., a stored dewpoint chart or LUT), temperature data, and/or humidity data. For example, vehicle sensors 108 may provide real-time temperature data and/or humidity data.

In the illustrated implementation, vehicle 102 includes a forward-facing camera 208A that has a field of view 240 the encompasses a windshield of vehicle 102. In addition to the windshield, the field of view 240 may also encompass the side-view mirrors of vehicle 102, or a separate camera may be used for the side-view mirrors. An operator's line of sight through the windshield may include multiple areas, and a vision obstruction 220 on an operator side of the windshield may be captured, a vision obstruction 222 on a center of the windshield may be captured, and a vision obstruction 224 on a passenger side of the windshield may be captured within the field of view 240 to collect data on potential vision obstructions in a sightline of an operator of a vehicle 102. In the illustrated implementation, vehicle 102 also includes a reward-facing camera 208b that has a field of view 242 the encompasses an operator-side side window of vehicle 102, a field of view 244 that encompasses a passenger-side side window, and a field of view 246 that encompasses a rear window of vehicle 102. An operator's line of sight through these other windows is used for lane changes, driving in reverse, etc., and a vision obstruction 226 on an operator-side side window may be captured within field of view 242, a vision obstruction 230 on a rear window may be captured within field of view 246, and a vision obstruction 228 on a passenger-side side window may be captured within the field of view 244 to collect data on potential vision obstructions in a sightline of an operator of a vehicle 102.

Data in the form of images captured by cameras internal to the vehicle 102, such as 208A, 208B, or a DSMC may be analyzed using known techniques to detect or determine the presence of a vision obstruction such as form of fog, fogged windows, blowing dust, snow, snow or ice-covered windows, road spray, mud splatter, heavy rain, sun glare, or the like. In another example, with respect to sun glare, brightness can be estimated by using the camera 208A as a luminance meter. Known image analysis techniques, such as detection of a decrease in contrast variation to detect fog, dust, or snow, may be used.

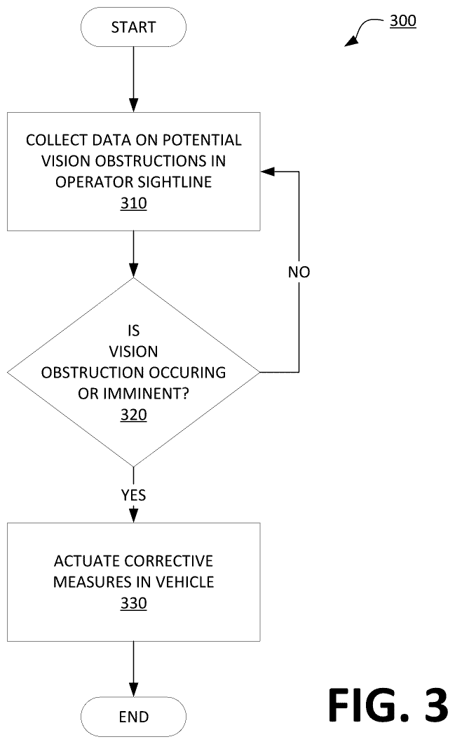

With reference to FIG. 3, a flow diagram is illustrated for a process 300 for vision obstruction monitoring. In a first block 310, a vehicle computer 104 such as an electronic control unit (ECU) collects data on potential vision obstructions in a sightline of an operator of the vehicle 102. This data may include camera data having images of windows of vehicle 102 in the operator's sightline, such as described with respect to FIG. 2. Alternately or additionally, this data may include temperature data and humidity data collected by sensors 108 with respect to air inside the vehicle 102 or outside the vehicle 102 which may condense to fog an inside or outside surface of a window of the vehicle 102, respectively. Such temperature data and humidity data may be used by vehicle computer 104 to determine that a vision obstruction in the form of window fogging is occurring or is about to occur based upon a dewpoint chart or look up table (LUT), as discussed below with respect to block 320. The LUT can be populated from empirical testing of various vehicle variants or types in various environments (e.g., ambient temperatures and humidities), for example.

Alternately or additionally, historical and/or current environmental data for a location of the vehicle may be stored in a computer 104 memory and/or retrieved by communication module 110 from a database 122 via wide area network 116 and central computer 120. Historical data may, for example, be used to determine the likelihood that overnight conditions will result in frost on windows of vehicle 102 when parked, or, in another example, current environmental data may be used to determine the likelihood of fog, blizzard, or sun glare conditions based on the position and direction of travel of the vehicle 102. Alternately or additionally, the current environmental data may be retrieved by communication module 110 from a source of local weather reports, such as weather radio or infrastructure broadcasts, which may include data on fog, snow intensity, rain intensity, dust storms, etc., that may affect visibility. Alternately or additionally, data from vehicle subsystems 106 may be used to infer visibility obstructions, such as a high windshield wiper speed to infer heavy rain, maximum defrost settings to infer window fogging, operation of fog lights to infer atmospheric fog, etc. Empirical testing or observation can be performed to establish values and/or combinations of environmental data predictive of fog, blizzard, or sun glare conditions.

In a second block 320, the vehicle computer 104/ECU determines, based on the data, that a vision obstruction has occurred or is about to occur. As previously discussed, camera data (for example, from DSMC or forward- and rearward-facing cameras) may be analyzed by known techniques to detect vision obstructions in images of windows/mirrors of vehicle 102, so as to detect that a vision obstruction is occurring in an operator's line of sight due to fog, fogged windows, blowing dust, snow, snow or ice-covered windows, road spray, mud splatter, heavy rain, sun glare, or the like. Alternately of additionally, temperature data and humidity data collected by sensors 108 with respect to air inside the vehicle 102 or outside the vehicle 102 may be analyzed relative to dewpoint conditions to determine that fogging of an inside or outside surface of a window of the vehicle 102, respectively, is occurring or is about to occur based on the dewpoint chart or LUT.

Alternately or additionally, historical and/or current environmental data may be analyzed and used to determine the likelihood that overnight conditions caused frost on windows of vehicle 102 when parked (e.g., based upon temperature, humidity, radiation cooling and wind conditions), or, in another example, current environmental data may analyzed to determine the likelihood of fog (e.g., based on temperature, humidity, windspeed, air pressure), blizzard (e.g., based on doppler radar), or sun glare conditions (e.g., based on time of day, sun position, local reflective surfaces) in combination with the position and direction of travel of the vehicle 102. Alternately or additionally, the current environmental data may be used to determine if data on fog, snow intensity, rain intensity, dust storms, etc. may affect visibility. Alternately or additionally, data from vehicle subsystems 106 may be used to infer visibility obstructions, such as a high windshield wiper speed to infer heavy rain, maximum defrost settings to infer window fogging, operation of fog lights to infer atmospheric fog, etc.

While vehicle computer 104/ECU may determine that a vision obstruction has occurred, in any or all of the above scenarios, operator input may also be used to confirm or deny the presence of a vision obstruction, such as those related to window condensation or other visibility issues. Such operator input may be used to refine the determination process on an individual basis (e.g., though machine learning) for a particular vehicle 102 or on a collective basis (e.g., though machine learning or via V2V communication) for all or nearby vehicles 102.

In a third block 330, the vehicle computer 104/ECU actuates or instructs another ECU to actuate a corrective measure in the vehicle 102. In an implementation, this may involve activating a climate control of the vehicle selected from, for example, a defrost function, an air-conditioning function, or heat function, as well as actuating the air-control louvers associated with these functions. Alternately or additionally, actuating a corrective measure may include activating a window motor to raise or lower a window, such as by sending instructions to an ECU of a body control module. Alternately or additionally, actuating a corrective measure may include activating a display, such as by instructions to an ECU controlling the HMI, to provide instructions to the operator on an instrument panel display or an in-vehicle infotainment screen indicating steps to take to resolve the vision obstruction. For example, the instructions may advise the operator to pull the vehicle to the side of the road, stop, and remove snow from the roof and rear window to correct a vision obstruction of the rear window, or remove snow from a hood and windshield to correct a vision obstruction of the windshield due to blowing snow.

Alternately or additionally, actuating a corrective measure may include disabling an advanced driver assistance system (ADAS) or preventing the ADAS from being enabled. As noted above, if an operator's vision is obstructed, then the operator may have difficulties in supervising the ADAS. Typically, an operator will be advised, e.g., via output on the vehicle HMI, that the ADAS will be disabled or cannot be enabled due to the vision obstruction, and in certain cases, it may be advisable to operate an autonomous driving (AD) function, as discussed below, to move the vehicle 102 off of a roadway until the vision obstruction is resolved.

Alternately or additionally, actuating a corrective measure may include activating an autonomous driving (AD) function of the vehicle 102 to take the vehicle 102 to the side of the road and stop the vehicle 102 until the vision obstruction is no longer determined. An AD function means an operation that controls at least one of vehicle 104 propulsion, braking, or steering. This may, for example, be a suitable corrective action in the case of heavy fog, a blizzard, or sandstorm, where activation of climate controls, windows, etc. are unable to address the vision obstruction.

While disclosed above with respect to certain implementations, various other implementations are possible without departing from the current disclosure.

Use of in response to, based on, and upon determining herein indicates a causal relationship, not merely a temporal relationship. Further, all terms used in the claims are intended to be given their plain and ordinary meanings as understood by those skilled in the art unless an explicit indication to the contrary is made herein. Use of the singular articles “a,” “the,” etc. should be read to recite one or more of the indicated elements unless a claim recites an explicit limitation to the contrary.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer comprising a processor and a memory, the memory storing instructions executable by the processor to:
collect data on potential vision obstructions in a sightline of an operator of a vehicle;
determine, based on the data, that a vision obstruction has occurred or is about to occur; and
actuate a corrective measure in the vehicle.

2. The computer of claim 1, wherein the instructions to actuate the corrective measure include instructions to disable an advanced driver assistance system (ADAS) or prevent the ADAS from being enabled.

3. The computer of claim 1, wherein the instructions to collect data on potential vision obstructions include instructions to collect camera data of views through windows of the vehicle.

4. The computer of claim 3, wherein the camera data is from a driver state monitoring camera (DSMC) and/or a forward-facing camera and a rearward-facing camera in an interior of the vehicle.

5. The computer of claim 1, wherein the instructions to collect data on potential vision obstructions include instructions to collect estimates of environmental conditions.

6. The computer of claim 5, wherein the estimates of environmental conditions include real-time or near real-time weather reports for a location of the vehicle, windshield wiper speed, dewpoint data, temperature data, and/or humidity data.

7. The computer of claim 1, wherein the instructions to actuate the corrective measure include instructions to activate a climate control of the vehicle, wherein the climate control is one of defrost, air-conditioning, or heat.

8. The computer of claim 1, wherein the instructions to actuate the corrective measure include instructions to activate a window motor to raise or lower a window.

9. The computer of claim 1, wherein the instructions to actuate the corrective measure include instructions to activate a display to provide instructions to the operator indicating steps to take to resolve the vision obstruction.

10. The computer of claim 1, wherein the instructions to actuate the corrective measure include instructions to activate an autonomous driving (AD) function of the vehicle to take the vehicle to a side of a road and stop the vehicle until the vision obstruction is no longer determined.

11. A method for operating a vehicle, comprising:
collecting data on potential vision obstructions in a sightline of an operator of the vehicle;
determining, based on the data, that a vision obstruction has occurred or is about to occur; and
actuating a corrective measure in the vehicle.

12. The method of claim 11, wherein actuating the corrective measure includes disabling an advanced driver assistance system (ADAS) or preventing the ADAS from being enabled.

13. The method of claim 11, wherein collecting data on potential vision obstructions includes collecting camera data of views through windows of the vehicle.

14. The method of claim 13, wherein the camera data is from a driver state monitoring camera (DSMC) and/or a forward-facing camera and a rearward-facing camera in an interior of the vehicle.

15. The method of claim 11, wherein collecting data on potential vision obstructions includes collecting estimates of environmental conditions.

16. The method of claim 15, wherein the estimates of environmental conditions include real-time or near real-time weather reports for a location of the vehicle, windshield wiper speed, dewpoint data, temperature data, and/or humidity data.

17. The method of claim 11, wherein actuating the corrective measure includes activating a climate control of the vehicle, wherein the climate control is one of defrost, air-conditioning, or heat.

18. The method of claim 11, wherein actuating the corrective measure includes activating a window motor to raise or lower a window.

19. The method of claim 11, wherein actuating the corrective measure includes activating a display to provide instructions to the operator indicating steps to take to resolve the vision obstruction.

20. The method of claim 11, wherein actuating the corrective measure includes activating an autonomous driving (AD) function of the vehicle to take the vehicle to a side of a road and stop the vehicle until the vision obstruction is no longer determined.
